(19) United States
(12) Patent Application Publication
(10) Pub. No.: US 2016/0149430 A1
(43) Pub. Date: May 26, 2016

(54) METHOD AND DEVICE FOR CHARGING RECHARGEABLE CELLS (As Amended)

(71) Applicant: H-TECH AG, Schaan (LI)

(72) Inventors: Jörg HEMPEL, Bad Urach/Wittlingen (DE); Peter TSCHIGGFREI, Tisis (AT)

(73) Assignee: H-TECH AG, Schaan (LI)

(21) Appl. No.: 14/891,905

(22) PCT Filed: May 16, 2014
(86) PCT No.: PCT/EP2014/060062

§ 371 Date: Nov. 17, 2015

(30) Foreign Application Priority Data
May 17, 2013 (DE) 10 2013 105 119.7

(51) Int. Cl. H02J 7/00

(52) U.S. Cl. CPC H02J 7/0072; H02J 7/0047; H02J 7/0052

(57) ABSTRACT

A method for adaptively charging rechargeable cells, in particular lithium-ion cells, and a device for charging such cells. In order to propose a method for charging a lithium-based cell/a device for charging a lithium-based cell, where the capacity of the cell is optimally utilised, the charging time is drastically shortened, the durability of the cell is prolonged, a degeneration of a charged cell is practically prevented and/or an increase in capacity of the cell is made possible, a method is proposed which includes pulsed charging of the cell, wherein the charging current I_{L}, during the charging pulses exceeds the nominal charging current I_{Lmax} of the cell; and the cell is discharged between the charging pulses by means of load pulses.

The invention relates to a method for adaptively charging rechargeable cells, in particular lithium ion cells or lithium-based cells. Moreover the present invention relates to a device for charging such cells.

Reorientation in the production of electrical energy based on regenerative energy sources, in particular by means of photo-voltaics or wind power, increasingly requires efficient storage of the generated energy in order to have stored electrical energy available as and when needed.

In addition there has been a distinct increase in the number of portable and battery-operated devices which are driven by rechargeable batteries or cells, in particular for communication and in the building trade. With these devices the capacity of rechargeable batteries represents an essential functional feature. The factors influencing the capacity of rechargeable cells are, on the one hand, the geometric size which is traditionally achieved by an enlargement of the geometric dimensions of the cells or the battery. On the other hand the durability or number of maximum possible charging cycles plays a big role since with usual battery-operated devices the battery or cell is the first to fail, i.e. when it comes to the durability of the components of such devices the rechargeable batteries or cells are among those with the shortest service life.

Also characteristics like capacity, durability and charging time of rechargeable cells/batteries/storage modules are particularly important when it comes to accepting new technologies in the very quickly developing field of E-mobility with hybrid or electric vehicles. Here too the geometric dimensions and the weight of rechargeable cells play a very important role.

During recent months the lithium-ion-cell has proven to be particularly advantageous among rechargeable cells since it has a long lifespan with the number of charging cycles being high compared to other technologies. Lithium-ion-cells also have a high storage capacity compared to other rechargeable cells.

With lithium-ion-cells the cell is discharged to up to 30% of its capacity depending on the design, in other words 30% of the intrinsic energy stored in the cell is not available to the user since discharging the cell to below the threshold of 30% would lead to an irrevocable destruction of the lithium-ion-cell. If a cell is discharged to below this threshold, ions can become detached from the electrode material (Cu, Al), thereby destroying the electrode.

In addition, a cell containing today's lithium-ion-cells is charged to no more than 80% of its capacity since if the cell were charged to 100% this would take exponentially more time, because the current is normally subjected to a limit when reaching the end-of-charge voltage, whereby the last 20% of capacity is charged at a lesser amperage so that in terms of time less energy is stored or loaded into the cell.

This again highlights the fact that charging a cell with the usable capacity should be performed as quickly as possible but also very carefully in order to achieve a maximum number of charging cycles on the one hand, and on the other, to keep the time required for charging as short as possible since the times available for this strongly depend upon user behaviour.

A known method for shortening the charging time of lithium-ion-cells is pulse-charging. In this respect the U.S. Pat. No. 5,481,174 describes a method for charging lithium-ion-cells where a positive and a negative pulse are used, wherein, after reaching a pre-set maximum voltage, the height of the positive current pulses is reduced thereby resulting in a long charging process.

Based on this situation it is the requirement of the invention to propose a method for charging a lithium-based cell/a device for charging as lithium-based cell, where the capacity of the cell is optimally used and/or the charging time is drastically shortened and/or the durability of the cell is prolonged and/or degeneration of a charged cell is practically prevented.

The invention is based on the idea of charging a rechargeable cell or battery at a faster rate than normal. To this end a pulse-charging method is proposed where the cell on the one hand is charged in a very caring and efficient manner and where on the other hand, the charging time is used as effectively as possible.

Further a charge-preparing phase may also be provided where the rechargeable cell is prepared or activated for the pulse-charging phase. For the purpose of achieving the above-mentioned goals it is sufficient however, to perform only the pulse-charging phase.

The pulse-charging phase according to the invention will now be initially explained in detail. During the pulse-charging phase a pulsed charging method is applied wherein the cell is charged with a charging current I_{L} which exceeds the maximum admissible charging current I_{Lmax} of the cell, for example by up to five times the value specified by the manufacturer on his data sheet. The pulsed charging method is composed of positive pulses and negative pulses. The negative pulses represent loading the cell with a defined load, in other words, the cell discharges energy or a current is flowing in reverse direction. Whilst the positive pulses are called charging pulses, the negative pulses may be called load pulses or discharging pulses. The term reverse pulse is also used sometimes. During the charging pulses a voltage pulse is applied with a corresponding current pulse. Following the charging pulse the voltage is switched off and the cell is connected to a sink or a load for the load pulse, i.e. a current is flowing in reverse direction. The voltage at the cell drops depending on the charging state of the cell during the time of the load pulse.

By applying a charging current which is higher than the maximum admissible charging current storing of the energy in the cell is quicker than when applying the maximum admissible charging current. In this way more ions are transported from one electrode to the other during charging, which than move back when a load is applied. If the storing of energy were performed with a charging current higher than the admissible charging current continuously over a longer period of time, the cell would heat up and the safety mechanisms (PTC, melting fuse, degassing valve, balancer) built into the cell would interrupt a charging operation of this kind. Due to a continuous charging operation dendrites are constantly accumulated on the electrodes of the cell, which on the one hand increase the internal resistance of the cell resulting in an increase in voltage at the cell. On the other hand, due to the increasing number of dendrites the number of possible charging cycles is also reduced.

According to the invention, however, it is proposed to have a load pulse following a charging pulse. During this load pulse the current in the cell flows in the opposite direction because the cell again releases energy. Thus the remanence accumulated during the charging pulse is diminished during the following load pulse. The load pulse has the effect of removing dendrites or crystals which accumulate during the charging pulse. The crystals or dendrites may lead to the separator in the cell between cathode and anode being punctured which in the worst case would lead to a short circuit. The load pulse causes the accumulated crystals to be repeated removed. Therefore the cell during the next charging pulse can be charged with a higher charging pulse than the admissible charging pulse without it becoming overheated. The higher charging current during the positive pulse causes more energy to be stored in the cell than with conventional charging methods. The following load pulse counteracts the constant formation of dendrites, allowing the cell to be charged again with a higher charging current. The height of the load pulse is less than that of the charging pulse, or in other words, the absolute amperage during the load pulse is smaller. Thus the channels in the separator are flushed out for ion exchange, whereby however, due to the higher charging current an increasing amount of energy remains in the cell.

Due to the short high charging currents and the subsequent load pulses the separator is formatted. The height of the load pulses are a means for adjusting the level of flushing of the separator. The smaller the load pulses, i.e. a small load current, the less is the flushing effect. The duration of load pulses has an influence in particular on the amount of discharge, i.e. even when working with a very high load current but a very short load pulse duration, a flushing effect is achieved, the amount of released energy being small due to the short load pulse.

The flushing effect on the one hand prevents an uneven distribution or deposition of the lithium or the ions on one of the electrodes. Moreover due to the short charging pulses and load pulses the temperature in the cell is prevented from reaching critical heights. Since the pulses in both current directions are short the temperature on the electrodes cannot markedly increase. In addition a possible increase in temperature on the electrodes can reduced again in the time between the pulses. A critical increase in temperature would result in an uneven resistance distribution in the electrodes, and thus ultimately in an uneven deposition of the lithium on the electrodes.

In a cell the terminal lugs are normally arranged diagonally to each other, i.e. the line resistances in the electrodes are different, in particular in a wound cell. For long and short charging currents, a. o. also for slowly pulsed charging currents, the lithium ions try to migrate in direction of the smallest resistance, i.e. they would try not to take the shortest route to the opposite electrode, but to migrate directly to the oppositely poled terminal lug. This however would have the effect of the lithium being unevenly deposited on the electrodes. An uneven deposition of the lithium on the electrodes however leads to a reduction of the lifespan and a reduction in the capacity of the cell since the whole of the electrode surface is no longer available for chemical reaction.

Due to the short charging pulses with increased charging current and also due to the load pulses however, the ions do not have the time to look for the path with a shortest resistance and must choose the shortest route between the electrodes, the entire electrode length being thus available for ion exchange and the deposition of the lithium remaining evenly distributed between the electrodes.

Preferably the charging current during the charging pulses is more than 1.5 times the nominal charging current of the cell, for example twice or three times the maximum admissible charging current or more. Charging currents are possible up to 5 times the maximum admissible charging current. The charging current I_{L} delivered during the pulse-charging phase/the discharging current I_{Last} (also called load current) withdrawn is limited only by a PTC in both current flow directions, the conductivity of which is dependent on the temperature. Depending on the design of the cell the PTC is configured such that it corresponds to 5 times or 10 times that of the charging current I_{Lmax}. The PTC would interrupt the current flow if a stronger current were flowing.

After a certain charging time and a corresponding number of charging pulses the voltage U_{Z} exceeds or reaches the end-of-charge voltage U_{Lmax}. With conventional charging methods the current would now be limited such as in the U.S. Pat. No. 5,481,174, for example. With the inventive charging method also, after reaching the end-of-charge voltage U_{Lmax} during a charging pulse, the current level for the charging pulse is reduced. The reduction is carried out by the charging program which is processed by a charging device. In order to prevent s further increase in voltage at the cell U_{Z} during the charging pulse, the current is reduced as early as during the current charging pulse in which the end-of-charge voltage U_{Lmax} was reached.

According to one aspect of the invention the pulse-charging method comprises the following steps: pulsed charging of the cell, wherein the charging current I_{L} during the charging pulses exceeds the admissible maximum charging current I_{Lmax} of the cell by up to 5 times its value; and the cell is discharged between the charging pulses by means of load pulses, wherein the load pulses are shorter than the charging pulses. According to the invention a maximum number m_{Max} of applicable charging and/or load pulses is predefined and the charging method is finished when this predefined number m_{Max} is reached. In addition to the above mentioned advantages this has the effect that the charging time is not unnecessarily prolonged, since for a constant reduction of the charging current or for decreasing current levels during the charging pulses the amount of energy stored in the cell remains small in comparison to the required time.

According to another aspect of the invention the method for charging at least one lithium-ion-based rechargeable cell comprises the following steps: checking whether at least one predefined condition for a pulse-charging method is met, wherein when at least one of the predefined conditions for pulsed charging of the cell has been met, a pulse-charging method is started wherein the charging current I_{L} during the charging pulse exceeds the admissible maximum I_{Lmax} of the cell by up to 5 times its value; and the cell is discharged between the charging pulses by means of load pulses, wherein the load pulses are shorter than the charging pulses.

Preferably the predefined conditions include at least one of the following criteria: presence of a voltage U_{Z} at the cell during a load pulse, which at least corresponds to an end-of-discharge voltage U_{EL} of the cell; or an external signal which indicates an urgency for performing the pulse-charging method.

Based on one of these conditions it can be ensured that the pulse-charging method is started only under certain conditions, on the one hand. Since the pulse-charging method represents a fast-charging method, the cell must meet at least predefined basic criteria, for example it must not comprise a deep discharge state or other critical states. On the other hand conditions must be met by the application or the controlling device which require pulse charging, for example fast charging of an electric car at the petrol station, i.e. an external signal should be present which requires fast charging.

According to one further aspect of the invention a method for charging at least one lithium-ion based rechargeable cell comprises the following steps: pulsed charging of the cell, wherein the charging current I_{L} during the charging pulses exceeds the admissible maximum charging current I_{Lmax} of the cell by up to 5 times its value; and the cell is discharged between the charging pulses by means of load pulses, wherein the load pulses are shorter than the charging pulses, wherein after reaching the end-of-charge voltage U_{Lmax} the duration of the charging pulses is reduced.

This has the advantage that a reduction in the charging current during a charging pulse is avoided as far as possible at least for the following charging pulses. The excessive charging current I_{L} is maintained during the shortened charging pulses since otherwise the charging process would be prolonged because the duration of the charging pulses with a sinking charging current would not be optimally utilised. Thus it is ensured that the excessive charging current can nevertheless be utilised because then the duration of the charging pulse in which the excessive charging current is applied, is reduced. As a result a further shortening, in particular of the charging process, is achieved, since pulsing with the excessive charging current is continued as long as possible and the charging current is not reduced until due to the charging pulse shortening a voltage increase at the cell can no longer be prevented. In other words, the at least one cell reaches its end-of-charge state faster.

According to one aspect of the invention a method for charging at least one lithium-ion based rechargeable cell comprises the following steps: pulsed charging of the cell, wherein the charging current I_{L} during the charging pulses exceeds the admissible maximum charging current I_{Lmax} of the cell by up to 5 times its value; and the cell is discharged between the charging pulses by means of load pulses, wherein the load pulses are shorter than the charging pulses, wherein prior to and/or after a load pulse the voltage supply is switched off for a predetermined rest period or no charging current is supplied, wherein the rest period depends upon the number and/or capacity of the cells to be charged.

The rest period allows the cell time to adjust to the discharging current during the load pulse or to the charging current during the charging pulse. After switching off the voltage for the charging pulse/switching off the load following the load pulse, the current direction in the cell reverses. In order to avoid stressing the cell a rest pause is applied before and after the load pulse.

Preferably the predetermined rest period increases for an increasing number of cells to be charged which are coupled to a terminal element. For an increasing number of cells coupled to a terminal element, i.e. connected in parallel, the current flowing across this terminal element increases. Reversal of the current direction with the current rising creates the need for a prolonged rest pause between the pulses. Without rest pauses between charging pulses and load pulses the discharging current during the load pulses would not be fully effective and the tensions in the cell/in the storage module with several cells could not reach equilibrium. The voltage would thus be forced into the opposite direction. By inserting rest pauses between the charging pulses and the load pulses these disadvantageous aspects are avoided.

Preferably the number of cells at a terminal element is limited to a maximum of five.

Pulse-charging is terminated in particular once a predetermined maximum number m_{Max} of applicable charging and/or load pulses is reached.

Shortening of the duration of the charging pulse after reaching the end-of-charge voltage U_{Lmax} can be combined with all other embodiments, i.e. with limiting the maximum number and/or with checking as to whether the conditions for pulse-charging have been met.

The use of rest periods before and/or after a load pulse in which no charging current is supplied, wherein the duration of the rest time is dependent on the number and/or capacity of the cells to be charged, can also be combined with all other embodiments.

Preferably the level of the charging current I_{L} for the current charging pulse is set depending upon voltage measurements during the charging pulses, wherein, when the voltage U_{Z} of the cell during the charging pulse reaches the end-of-charge voltage U_{Lmax}, the duration of the charging pulse for the next charging pulse is reduced. In a preferred method, when the end-of-charge voltage U_{Lmax} is reached during the charging pulse, the charging current I_{L} is reduced during the current charging pulse.

In an exemplary arrangement the ratio between a discharging current I_{LAST} during the load pulse and a charging current I_{L} during the charging pulse is 1:16. It is, however, possible to apply a substantially higher discharging current I_{LAST} of 50% of the charging current I_{L}, or in exceptional cases of even 100% of the charging current I_{L} for very short load pulses. The short load pulses have the effect that the energy withdrawn from the cell is no more than was stored in it during the charging pulse. It has also become evident that the flushing effect at the separator is improved, in particular with very high discharging currents I_{LAST}. In other words the level and/or duration of the discharging current/the load pulse may vary in consecutive load pulses.

In an advantageous arrangement the voltage U_{Z} of the cell is measured at least outside the charging pulses in order to determine whether the cell reaches its end-of-charge voltage U_{Lmax} outside the charging pulse, preferably during the charging pulse. In addition or alternatively the voltage of the cell can be measured continually or periodically in order to obtain further information about the state of the one or more cells, wherein if a predetermined voltage at the cell is exceeded, the charging operation is aborted or interrupted. Should the voltage in a cell rise beyond the predetermined voltage of the cell, the cell comprises an irregularity which must be taken account of during further charging, either by adapting the charging current level or load current level or, in extreme cases, by aborting the charging process or by interrupting it in order to cool the cell. In order to determine the state of the cell, a voltage measurement is carried out on the cell preferably during at least one load pulse and/or charging pulse. In a preferred embodiment a voltage measurement is carried out during all load pulses. Since voltage measurement at the cell permits a realistic statement on the state of the cell only when under load, the voltage is measured during the load pulses. It is especially advantageous if the voltage is measured at the end of the load pulse, since then the most stable state of the cell is reached. I.e. the voltage is recorded at a point in time before the load pulse leaves its maximum and the current flows in direction 0. A voltage measurement without a load would result in voltage values which can no longer be achieved in a load state, since then the voltage rises extremely and the current collapses. For a better control of the charging pulses and/or load pulses and in particular for the height or duration of the pulses it is advantageous if the voltage of the cell is measured also during the charging pulse, in particular in order to detect voltage deviations in upward direction or in order to detect whether the end-of-charge voltage has already been reached.

Preferably the charging current I_{L} during the charging pulses is more than 1.5 times the maximum admissible charging current I_{Lmax} of the cell, preferably twice the maximum admissible charging current I_{Lmax} or greater.

In particular the level of the charging current I_{L} is set during the charging pulses and/or the level of the discharging current I_{LAST} is set during the load pulses in dependence of the state of the cell and/or in dependence of the internal resistance of the cell and/or the temperature of the cell.

In an advantageous arrangement the level of the charging current I_{L} in consecutive charging pulses varies and/or the level of the discharging current I_{LAST} in consecutive load pulses varies, i.e. the level is respectively adapted to the state of the cell, wherein here in order to detect the state the voltage measurement and/or a temperature measurement may be used. In particular, the charging operation is terminated or interrupted when a certain temperature of the cell is exceeded. The level of the discharging current I_{LAST} for the next load pulse can be set in dependence of the voltage measurement.

In an advantageous arrangement the length of a load pulse t_{EL} corresponds to about ⅓ of the length of a charging pulse t_{L}. The duration of the load pulse is dependent on the level of the load current. With this arrangement it is ensured that not only is a higher current supplied during the charging pulses than during the load pulses, but also that during the charging pulse the higher current is supplied for longer than during the load pulse, when energy is withdrawn from the cell. Admittedly ratios of ¾ for the charging pulse and ¼ for the load pulse are possible. The load pulse however must not be too long since otherwise the charging of the cell is unnecessarily prolonged. In a preferred embodiment the times of the pulses/their respective ratios can be set, in particular via the input unit on the charging device.

Preferably, once a predefined number of n load pulses is reached, in which the measured voltage U_{Z} corresponds to the end-of-charge voltage U_{Lmax} of the cell, cell charging is terminated, wherein n is preferably =1. I.e. after the voltage U_{Z} has reached the end-of-charge voltage U_{Lmax}, the pulse-charging process is finished.

Further in order to meet the requirement, a device for charging at least one lithium-ion based rechargeable cell is proposed, comprising a controller adapted to execute the above described method.

Preferably a sink is provided in order to discharge the cell during the load pulses, wherein the duration and height of the load pulse is adjustable. To this end at least one capacitor is used for example, which is charged during a load pulse and/or discharged during a charging pulse.

In an advantageous arrangement the device further comprises a memory for storing various parameters for the charging process; a display for outputting measured values, an input unit for manually influencing the charging process and for inputting predefined values; a temperature sensor for continuously or periodically monitoring the temperature of the cell, a storage module containing at least one lithium-ion based rechargeable cell, and a counter for recording charging pulses and/or load pulses during the pulse-charging process.

Preferably the cell is discharged between two positive charging pulses by means of a load pulse. But other charging patterns are possible, where only a pause takes place between two charging pulses and a load pulse does not happen until after two or more charging pulses.

This has, however, an effect upon the charging time, since the charging current during the charging pulses cannot be chosen quite as high as when a load pulse would follow between all charging pulses. I.e. as the charging state rises, the height of the load pulse can rise in order to reduce remanence. An adaptive arrangement of the height and duration of the charging pulses/the load pulses makes it possible to react to peculiarities during the charging process such as to external temperature influences. Also deviations of voltage trends during the charging pulses and/or load pulses may occur, which point to an uneven deposition of the lithium or which may have their cause in a short-term heating-up of the electrodes.

If voltage measurement during the charging pulses indicates a voltage increase outside the voltage trends, this may point to an irregularity during charging, which for example indicates an increased build-up of dendrites or a rise in temperature, causing the internal resistance of the cell to increase. In order to counteract this voltage increase, the height of the next charging pulse can be reduced in comparison to the previous charging pulse. I.e. when the voltage at the cell increases abruptly, the current in the next charging pulse is reduced. Preferably this will bring about a reduction by about 50% so that for a charging current twice as large in the previous charging pulse, charging is now effected for a charging pulse with only a one-time as large admissible charging current. Preferably the next load pulse or the load pulse following the reduced charging pulse may also be reduced by 50% in comparison to the previous load pulse. From the voltage measured during the load pulse can be derived, whether the next positive charging pulse must also be reduced or can be carried out again with increased charging current. If the voltage during the load pulse with reduced load is again in the predefined tolerance range, the next positive charging pulse can again be carried out with the previously applied increased charging current. Then the next load pulse can also be effected with the previously applied load, in order to discharge the cell in the short-term and to prepare it for the next positive charging pulse with increased charging current. Due to reducing the charging current/the discharging current the cell is given the possibility to reduce e.g. the temperature of the electrodes.

The voltage of the cell may increase, for example because of a defective PTC or an excessive internal resistance level of the cell, since the electrodes have become too hot. Then preferably both the charging pulses and the load pulses are reduced until the voltage of the cell has returned again to predefined voltage trends.

In a further preferred embodiment charging the cell is terminated, after during at least one load pulse the measured voltage corresponds to the end-of-charge voltage of the cell.

It is particularly advantageous if the last load pulses prior to reaching a 100% charge for the cell, are greater by about 25% than the previous load pulses, since for a rising voltage the remanence of the cell also rises because in this case the load pulse for discharging must be greater. Additionally or alternatively the current of the next charging pulse is reduced if the voltage during the load pulse reaches the end-of-charge voltage. Preferably the current in the next charging pulse is halved, this for so long until for the next load pulses the end-of-charge voltage remains stable. The charge of the cell is then 100%.

With all method steps it is advantageous to continuously or periodically measure the temperature of the cell. This gives further information whether the cell to be charged will behave normally during charging. As long as the temperature lies below predefined limit values, the charging process continues. A rise in temperature below predefined limit values can be counteracted by reducing the height or duration of the charging pulses. The temperature should be monitored at least during the charging pulse/the load pulse. If a predefined temperature (Tₘₐₓ) is exceeded for a predefined time, for example 45° C., for one or more charging pulses the charging operation of the cell is aborted. The critical temperature for both high-energy cells and high-current cells is 47-48° C.

What has been described up to now is the charging method in particular with respect to the pulse-charging phase. The above-described pulse-charging phase is instrumental in achieving enormous time savings during cell charging. As such it is possible with the charging method according to the invention to load the cell within 20% of the normal charging time, without the cell heating up or being permanently damaged. The short-time change between high charging pulses and load pulses prevents a rise in temperature of the cell beyond a critical temperature resulting in the resistance of the electrodes remaining the same and thus counteracting an uneven distribution of the lithium.

The charge-preparing phase described below, is used for activating the cell. It is particularly important to prepare deep discharged cells slowly for the pulse-charging process. But using the charge-preparing phase on its own also leads to improvements during the charging of lithium-ion cells.

Batteries are usually composed of several cells which are connected in parallel or on series. In batteries or power packs of this kind a balancer is provided which normally prevents deep discharging of the cells. With conventional cells a cell is said to be “discharged” if it still contains 30% of its capacity. If cells are discharged to deeper than 30%, this is called “deep discharge”. This may occur due to a defective balancer or if cells are loaded at extremely low temperatures or are stored in a discharged state at very low temperatures.

That is the reason why in order to further improve the charging process the charge-preparing phase is carried out prior to the pulse-charging phase, which comprises the following steps: measuring the voltage of the cell U_{Z} without load, setting the charging current level I_{L} in dependence of the measured voltage U_{Z}, setting the increase of the charging current I_{L} with respect to a predefined time t_{A}, charging the cell with a charging current I_{L} within a first linear rising phase up to the set charging current level over the predefined time t_{A}, wherein the charging current I_{L} corresponds, at its maximum, to the maximum admissible charging current I_{Lmax} of the cell, wherein after reaching the set charging current level the voltage U_{Z} of the cell is measured under a predefined load and the first linear rising phase is repeated once or several times in dependence of the voltage U_{Z} of the cell measured under load.

Preferably, if the measured voltage U_{Z} of the cell, after a first rising phase, lies above a first threshold value and below a second threshold value, a second linear rising phase is carried out with a charging current I_{L} which lies above the maximum admissible charging current I_{Lmax} of the cell. In particular it is measured whether the voltage U_{Z} of the cell under load reaches a predefined minimal voltage which permits pulse-charging, wherein then the pulse-charging phase is started after reaching the predefined minimal voltage, e.g. the end-of-discharge voltage.

As mentioned above, the charge-preparing phase includes a. o. a first measurement of the voltage of the cell without load, i.e. a measurement without previously supplying current. If the cell shows no voltage, the conclusion must be a defective cell. Depending on the measured voltage a charging current level is now set. The charging current level during the charge-preparing phase is limited for a first rising phase to the maximum admissible charging current level. Further the increase or the time is set, in which the charging current shall increase from zero or a low starting value to the specified charging current level. If the voltage measurement shows a very low voltage, 50% of the maximum admissible charging current for example should be applied during the first rising phase. The lower the voltage the longer should be the time for the first rising phase, i.e. the increase of the charging current is smaller for a low voltage.

Thereafter cell-charging is carried out with the specified charging current within a first linear rising phase up to the set charging current level, e.g. 1 A over the predefined time, e.g. 1 min, wherein the charging current, at its maximum, corresponds to the maximum admissible charging current of the cell. This charging is used for activating the cell so that the ions slowly begin to migrate from one electrode to the other. After reaching the set charging current level there is a pause without any charging current supply. The voltage of the cell can be measured as early as here. Then the voltage of the cell is measured for a predefined load. The predefined load is similar or equal to a load pulse in the pulse-charging phase. In addition a pause without current supply may be inserted before and/or after the charging pulse for measuring the voltage. Depending on the voltage of the cell measured under load the first rising phase is repeated. A repeat is important if the voltage under load does not yet show the desired value. For example the first rising phase is repeated if the end-of-discharge voltage of the cell is not yet reached after the first rising phase. This first rising phase with a charging current which at its maximum corresponds to the nominal charging current, can be repeated several times depending on cell type and the state of the cell. Once the cell under load shows a voltage which e.g. lies above the end-of-discharge voltage by more than 5%, a second rising phase may preferably be carried out, wherein the cell is charged in a linearly rising manner up to a predefined charging current which is higher than the nominal charging current. For example the cell can be charged during the second rising phase up to double the nominal charging current. At the end of the second rising phase the voltage of the cell under load is measured again. If a voltage is now reached which comprises a predefined value where the cell is suitable for the pulse-charging phase, the charge-preparing phase is finished. If the end-of-discharge voltage is reached as early as after one or several first charge-preparing phases, the second rising phase may be omitted.

Examples of the invention will now described with reference to the figures, in which

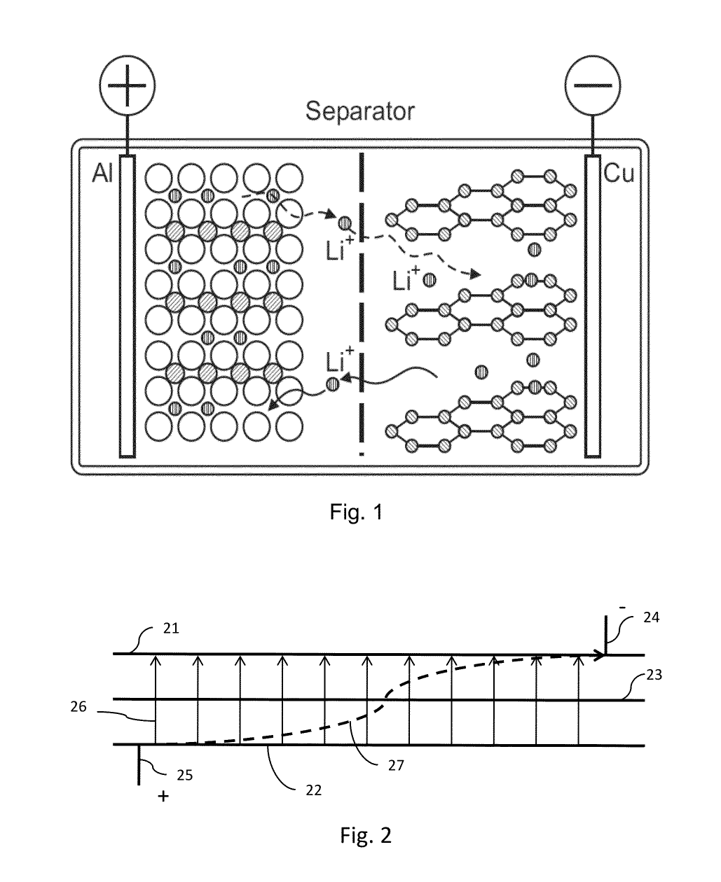

FIG. 1 shows the construction of a commonly used lithium-ion cell;

FIG. 2 shows a lithium-ion cell in a wound state;

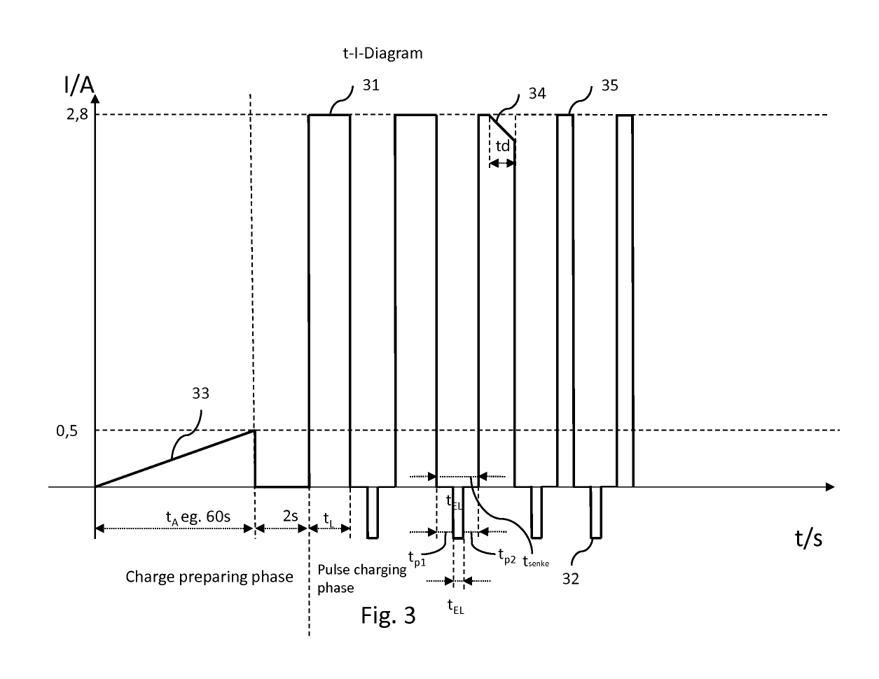

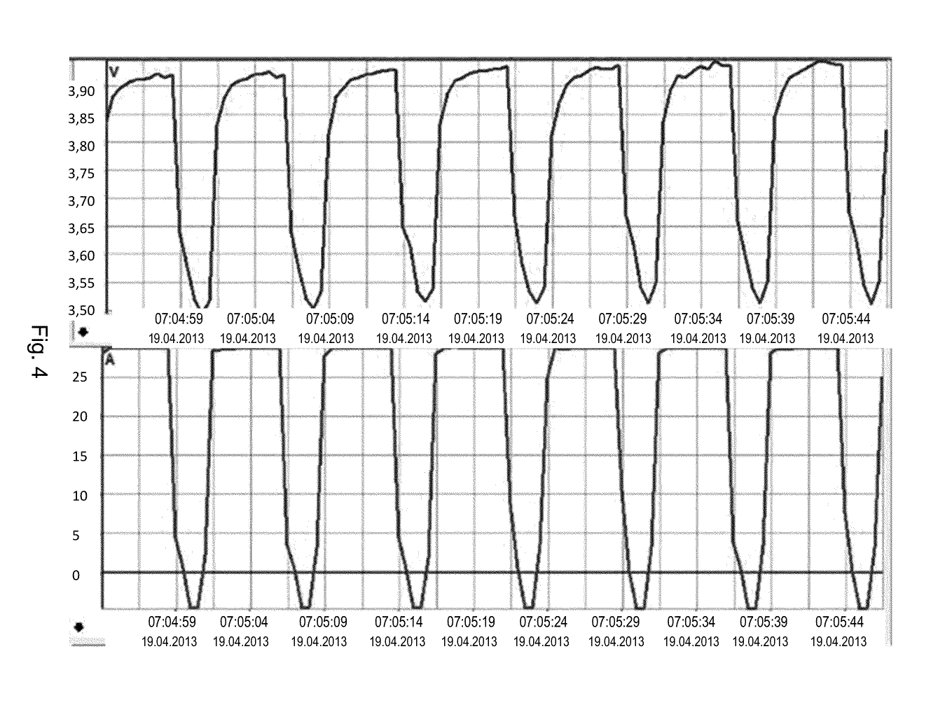

FIG. 3 shows a schematic current signal characteristic of a charging method according to the invention for a high-energy cell;

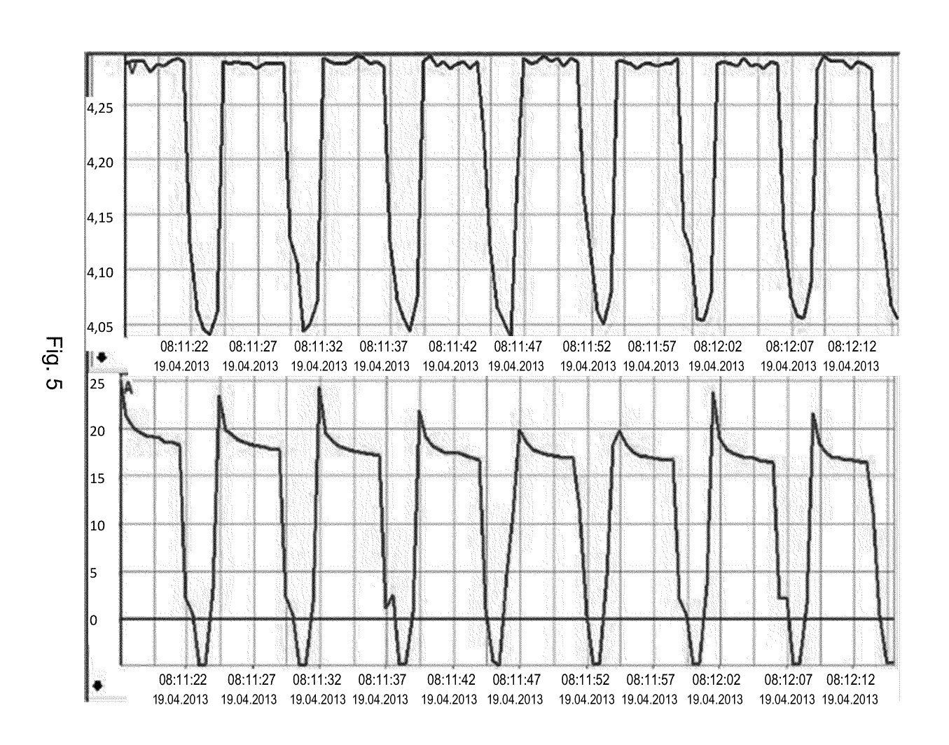

FIG. 4 shows a current and voltage characteristic at the start of a pulse-charging method according to the invention for a storage module with 10 high-energy cells;

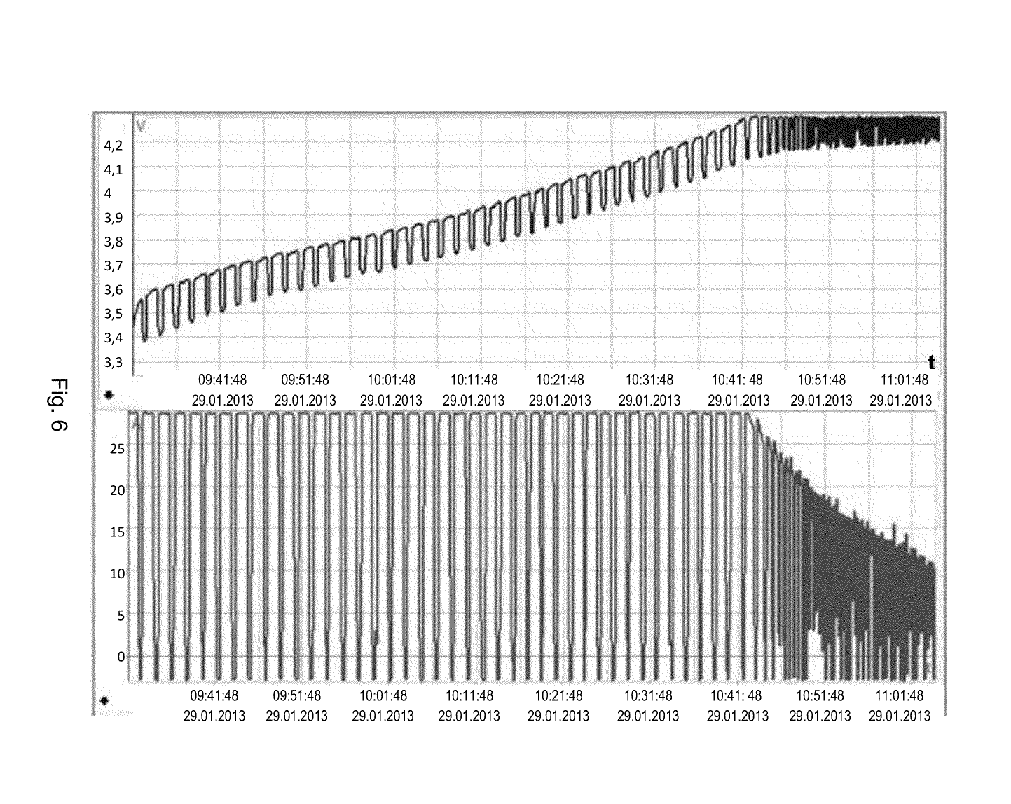

FIG. 5 shows a current and voltage characteristic at the end of a pulse-charging method according to the invention for a storage module with 10 high-energy cells;

FIG. 6 shows a current and voltage characteristic of the pulse-charging method according to the invention for a storage module with 10 high-energy cells;

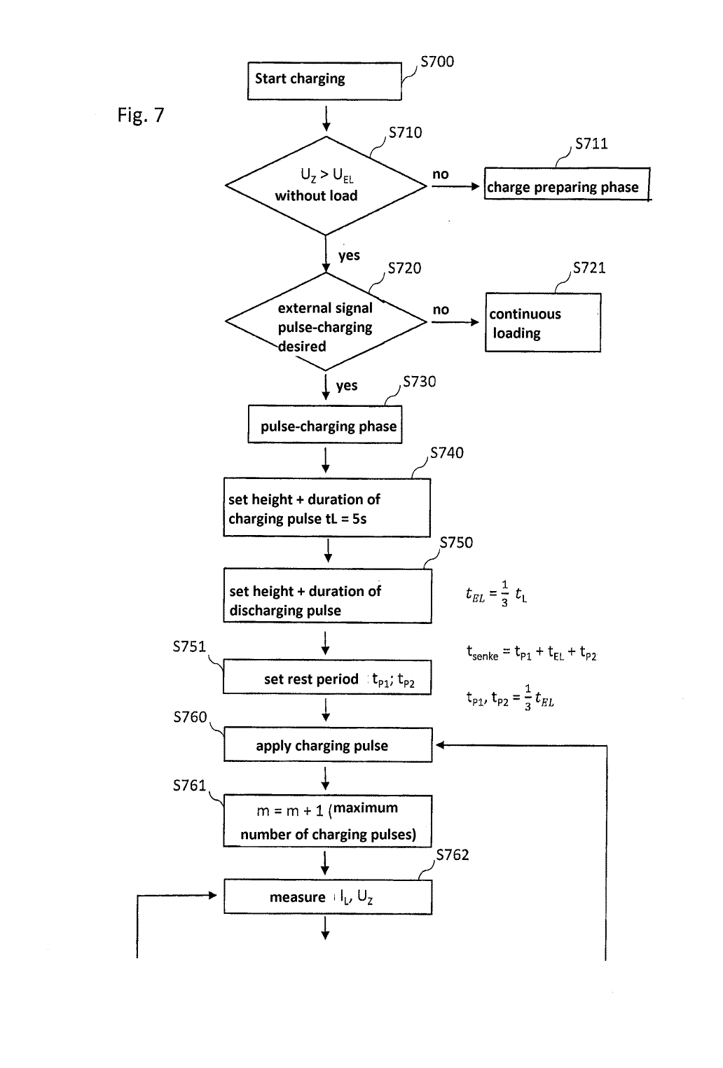

FIG. 7 shows a flow diagram for a charging method according to the invention;

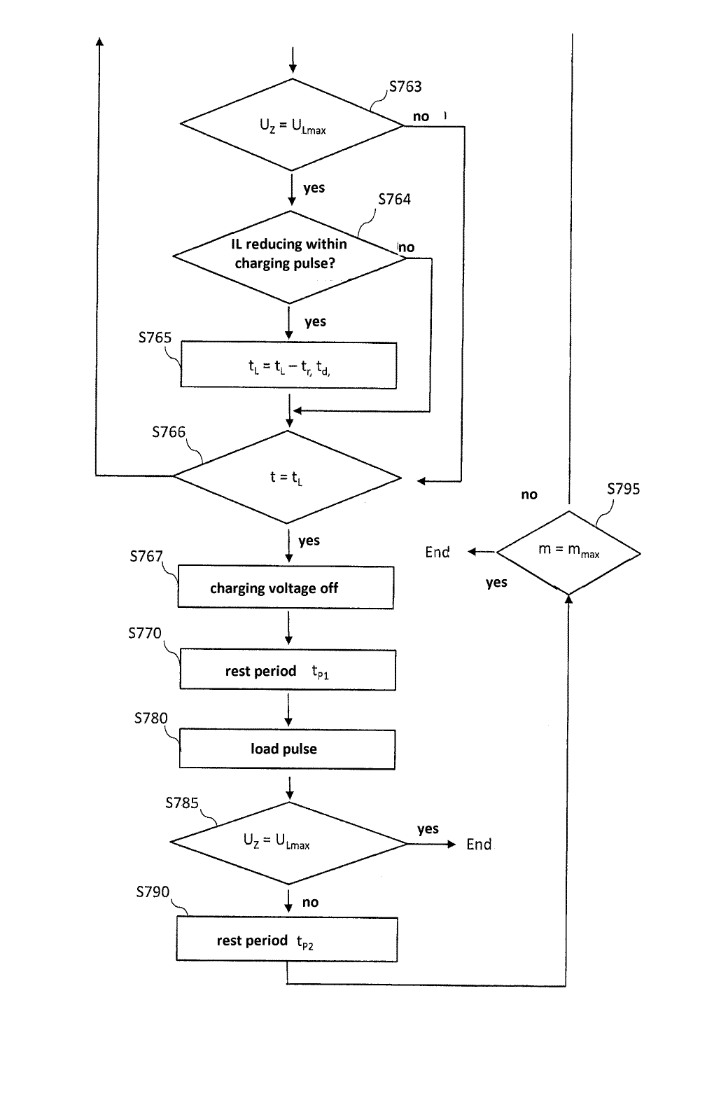

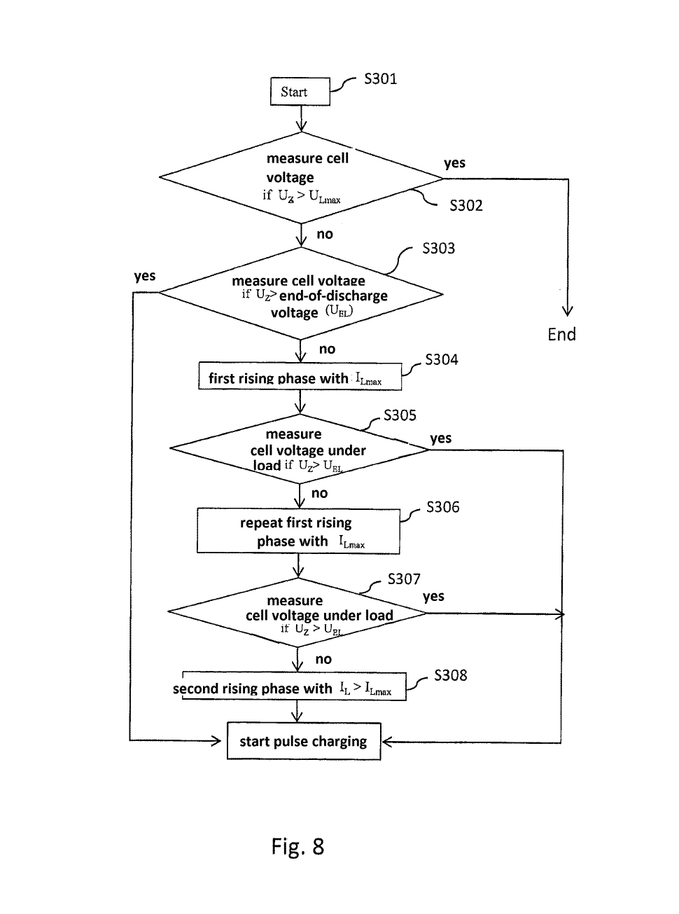

FIG. 8 shows a flow diagram for a charge-preparing phase according to the invention;

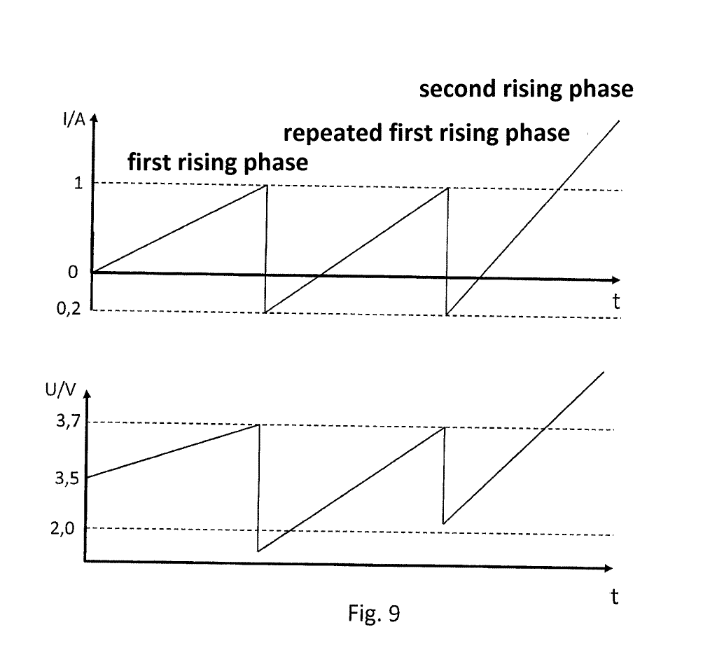

FIG. 9 shows an embodiment of a signal characteristic during the charge-preparing phase according to another embodiment;

FIG. 10 schematically shows the construction of a charging device for applying the pulse-charging method according to the invention;

FIG. 11 shows a storage module in which the adaptive pulse-charging method according to the invention is used.

FIG. 1 schematically shows the construction of a lithium-ion cell comprising a cathode and an anode. During the charging operation lithium-ions migrate from the positive electrode to the negative electrode which for example is coated with lithium graphite. During the discharging operation the lithium-ions migrate from the negative electrode back to the positive electrode. The two electrodes are separated from each other by a separator, wherein the lithium-ions migrate through this separator.

Lithium-ion cells compared to other rechargeable cells are characterised in that they have no memory effect and self-discharge is very low. The normal end-of-charge voltage U_{Lmax of} lithium-ion cells is approx. 4.2V, based on a nominal voltage of 3.6V. Lithium-ion cells, for example, include lithium polymer cells, lithium iron sulphate cells, lithium graphite cells and lithium cobalt cells.

FIG. 2 shows a lithium-ion cell in a wound state. The anode 21 and the cathode 22 lie opposite each other and are separated from each other by a separator 23. The terminal lugs 24 and 25 on the electrodes 21 and 22 lie diagonally opposite each other. That is, the electrical resistance in the electrodes increases as the line length increases. Thus the electrical resistance in the electrodes grows as the distance to the terminal lug increases. Therefore the lithium-ions endeavour to take the path of the least electrical resistance as they migrate from the positive to the negative electrode, which resistance, however, is not formed by the electrode directly opposite, but is located through the cell between the electrodes (indicated with 27). Due to the short charging pulses with the charging current I_{L}, which is higher than the nominal charging current I_{Lmax} of a cell, the lithium-ions are urged to the other electrode without having time to look for a path with the least electrical resistance. As a result the separator 23 is formed up thus permitting a uniform ion exchange between the two opposite electrodes 21 and 22. In addition due to the charging pulse being limited over time as well as the load pulse, the temperature of the electrodes 21, 22 is prevented from rising excessively which otherwise would cause an increase in the internal resistance of the electrodes which again would lead to an uneven resistance distribution causing a further rise in the temperature of the electrodes on the one hand and a change in the lithium distribution within the cell on the other, leading to an uneven distribution of the lithium deposition. An uneven deposition of lithium would lead to no longer having a complete chemical reaction surface available between the electrodes, thereby reducing the maximum possible charging cycles. On the other hand, if the lithium deposition were to grow unevenly on one of the electrodes, the separator would be reached at some time and be punctuated causing a short circuit. The short charging pulses or load pulses have the effect of counteracting this, wherein the prevention of an excessive rise in temperature is especially important. The reference symbol 27 shows a path of the lithium-ions which try to take the path of the least electrical resistance. If the cell were not charged/discharged with the short high charging pulses or load pulses, the lithium-ions would try to take the path represented by the reference symbol 27, which would lead to an uneven distribution of the lithium deposition on the electrodes.

FIG. 3 shows a signal characteristic over time for a charging method according to the invention with a charge-preparing phase and an adaptive pulse-charging phase for a single cell. The charging method shown here is exemplary for a high-energy cell with a capacity of 3.1 Ah. A cell of this kind comprises an end-of-charge voltage U_{Lmax} of 4.2V and a nominal voltage of 3.6V. The end-of-discharge voltage U_{EL} is 2.5V. The maximum admissible charging current I_{Lmax} is approx. 900 mA and the nominal discharging current is approx. 600 mA.

With this charging method the cell is charged during the charge-preparing phase with a first rising phase 33 with a charging current rising from 0 to approx. 0.5 A within one minute. After this one minute the charging operation is stopped for a duration of 2 s, i.e. the cell is no longer supplied with a charging current, wherein the voltage of the cell is measured at first without and then with a predefined load (not shown in the signal characteristic). After 2 seconds have passed and a voltage above the end-of-discharge voltage of 2.5V has been measured, the charge-preparing phase is finished and the pulse-charging process can begin.

In the pulse-charging phase the pulse duration of the positive charging pulses 31 is initially 5 s, wherein the duration of the load pulses 32 is 1.3 s. It should be noted that these values are only examples and may vary within the above-mentioned ranges. During the load pulses 32 the cell is loaded with 300 mA, wherein the voltage U_{Z} of the cell is measured within a load pulse 32. If the voltage at the cell during this load is more than 4.2V, the charging operation is finished. Although not shown, load currents of up to 2.8 A may also flow during the load pulses, in order to improve the flushing effect.

Within the cell the following happens during the charging operation according to the invention: the crystals being created inside the cell during the charging pulses 31 may damage the separator 23 of the cell, whereby this would lose both charge and capacity. Moreover the crystals obstruct the movement of ions between the electrodes 21, 22, resulting in a distinct reduction of the lifespan of the cell. However, since in the load pulses 32 according to the invention which lie between the charging pulses 31 these crystals are again immediately reduced due to the load, the negative effect of the crystals is cancelled. This constitutes a major advantage of the charging method according to the invention. According to the inventive charging method as per FIG. 3 charging pulses 31 of 2.8 A respectively are employed during the pulse-charging phase, leading to a charging current approx. three times greater than the maximum admissible charging current of 980 mA for high-energy cells.

With other conventional charging methods the charging current used is a constant one, but this is lowered when the end-of-charge voltage U_{Lmax} is reached. Due to the current sinking when the end-of-charge voltage U_{Lmax} is reached, a distinctly higher charging time is required, in particular for charging the remaining capacity of a cell. With traditional charging methods without load pulse the voltage moreover is measured during the interruption of the charging pulses. Because no load pulses are applied the crystals or dendrites formed during charging, which are capable of damaging the separator 23, are not removed. Due to the fact that these crystals are not removed again, commonly used charging methods must never make use of a raised charging current, which lies above the maximum admissible charging current I_{Lmax}.

There are also charging methods which charge at a continually rising current, wherein however a continually rising charging current I_{L} results in a degeneration of the cell, in particular if the cell is to be charged to 100%. Besides with charging methods, which employ a continually rising charging current, a considerable rise in temperature has been observed.

Due to the charging method according to the invention a defined sink is used during the load pulse 32 in order to remove the crystals or dendrites and to counteract a critical temperature increase. Due to the constantly removed crystals or dendrites during the load pulses a higher charging current can be utilised resulting in a drastic reduction in charging time. The pulses are short thus avoiding an excessive temperature increase and ensuring that the cell is charged carefully despite the higher current values and without losing out on the length of its service life. Moreover there is virtually no self-discharge due to non-existent crystals, a charged cell when in an idle state or when decoupled will not discharge and therefore not degenerate so that even after years of storage it can still develop its full capacity.

FIG. 3 shows the characteristic of the charging current for charging the cell, with the pulse-charging phase starting after the charge-preparing phase. The invention proposes to insert a rest period tp1 and tp2 before and/or after each load pulse 32. In other words, after the voltage for the charging pulse has been switched off, the current flowing through the cell sinks to zero. The rest period tp1 after a charging pulse and before a load pulse is shorter than the duration of the load pulse t_{EL}, in the shown example preferably 0.3 s. The rest period tp2 after the load pulse and before the charging pulse may be equal to the first rest period tp1, as shown in FIG. 3, but it may also be somewhat longer than the first rest period, e.g. 0.5 s. Due to the rest periods the cell is given the opportunity to adjust to the change in current direction, since the current follows the voltage and therefore does not drop to 0 A immediately on switch-off of the charging voltage, but only gradually as shown in FIGS. 4 and 5. This effect is not shown in FIG. 3.

In the third charging pulse a drop 34 in the charging current I_{L} can be recognised. This drop 34 occurs when the voltage at the cell reached the end-of-charge voltage U_{Lmax} during the charging pulse. This has the effect that the voltage at the cell does not rise any further. With conventional charging methods the next charging pulse would now take place with a reduced charging current, wherein the charging current, whenever the end-of-charge voltage U_{Lmax} is again reached, would drop further and further. The important disadvantage here is that the amount of energy stored in the cell is constantly reduced. As a result the charging time would be considerably increased.

The present invention proposes to shorten the duration of the next charging pulse 35 after the end-of-charge voltage U_{Lmax} has been reached. This is advantageous for the reason that also during the subsequent charging pulses the raised charging current is used with a reduction in charging time being nevertheless possible. This can be accomplished in several ways. On the one hand the next charging pulse 35 may be shortened by the time td, in which during the previous charging pulse the charging current was lowered. But it is also possible to constantly reduce the duration of the charging pulse. For example, on reaching the end-of-charge voltage U_{Lmax} the next charging pulse 35 may be reduced (not shown) by a predefined value tᵣ, i.e. always by 0.2 s.

FIG. 4 shows a voltage characteristic and a current characteristic at the start of the pulse-charging method, with the voltage being shown during pulse charging in the upper part and the current being shown in the lower part of the figure. In FIGS. 4-6 each power pack comprises 10 cells, as shown in FIG. 11. It can be clearly seen that the voltages during the charging pulses at the start of the pulse-charging process are below the end-of-charge voltage U_{Lmax} (3.85-3.95V), wherein the voltage at the cell U_{Z} drops during the load pulses, because the cell is still at the beginning of the charging process and is in the range of 3.5V. The corresponding current characteristics during the charging pulses/the load pulses are shown in the lower part of FIG. 4. Here it can be seen that the high-energy cells in the power pack are charged with approx. 28 A during the charging pulses. The admissible charging current I_{L} for a high-energy cell is normally approx. 0.9 A, i.e. for 10 cells in a power pack a current of 9 A is flowing. Therefore with the charging method according to the invention a charging current I_{L} is used which is approx. three times as high during the charging pulses. When a charging pulse is finished and the charging voltage U_{L} is switched off, a first rest period tp1 occurs, before the load pulse is applied, i.e. the cell is connected with a sink, such as a capacitor or resistance, which causes a current to flow in the opposite direction. The duration of the load pulses t_{EL} lies distinctly below 50% of the duration of the charging pulse t_{L}, preferably in the region of 20-30%. During the charging pulse in this example, a discharging current I_{Last} of 5 A is flowing. During the entire sink time tₛₑₙₖₑ, i.e. outside the charging pulses, the voltage at the cell U_{Z} is monitored in order to determine whether the end-of-charge voltage U_{Lmax} is already present during the charging pulse. In the load pulses according to FIGS. 4 and 5 the load current I_{Last} used is less than 3 A. Experiments have shown, however, that with a load current I_{Last} of 10 A or 18 A, i.e. approx. 30% or 55% of the charging current, total charging time is not prolonged, but the cycles are higher. In other words, load pulses which comprise a load current of approx. 50% or more of the charging current, can be used to efficiently prevent a degeneration of the cell without the charging time being prolonged.

As can be recognised for a load cycle from FIG. 4, for each subsequent charging pulse there occurs a rise both in the voltage in the ring the charging pulse and the voltage at the cell U_{Z} during the load pulse. FIG. 4 shows only a very short section at the start of the pulse-charging method according to the invention. The times for the charging pulses t_{L}/load pulses t_{EL} can be read on the X-axis. It can be recognised that two division units (boxes) correspond to 5 s, i.e. one load pulse lasts less than 2 s, wherein one charging pulse lasts 5 s.

Similarly to FIG. 4 FIG. 5 also shows a voltage characteristic in the upper part and a current characteristic in the lower part for the pulse-charging process. In contrast to FIG. 4 this view shows the pulse-charging process shortly before the end. The charging pulses already comprise a voltage of over 4.25V which approx. corresponds to the end-of-charge voltage U_{Lmax}. During the load pulses the voltage of the cell U_{Z} drops to approx. 4V. This is a distinct sign that the cell is almost completely charged. When the end-of-charge voltage U_{Lmax} of approx. 4.25V is reached during the charging pulses, as shown in FIG. 5, the charging current is reduced during the charging pulses. This can be recognised by the sharp rise in the charging current at the start of the charging pulse, wherein the charging current is then distinctly lowered by the charging device. Without this lowering the voltage of the cell U_{Z} would rise further. Therefore the invention proposes to reduce the duration of the charging pulses t_{L} once the end-of-charge voltage U_{Lmax} is reached during the charging pulses and after the charging device during a charging pulse reduces the charging current I_{L}, as can be recognised in the lower part of FIG. 5. To this end the duration of the charging pulse t_{L} in the upper part of the charging pulse is considered prior to voltage switch-off which also leads to a steep drop in current. It can be recognised that in the first three charging pulses the charging pulse duration t_{L} is still almost 5 s. The charging pulse duration of the subsequent charging pulses however, is shortened. This can be recognised, for example, in the last charging pulses of FIG. 5, the width of which in the area prior to voltage switch-off lies distinctly below 5 s.

Shortening of the duration of the charging pulses is based on the fact that due reducing the current within a charging pulse the cell is no longer charged efficiently and therefore the time of the charging pulses is no longer utilised efficiently. In order, however, to utilise the time of the charging pulses effectively, the invention proposes to shorten the duration of the charging pulses t_{L} in order to prevent the charging device from lowering the charging current I_{L} during the charging pulses and thus to charge the cell with the maximum possible charging current, albeit for a reduced duration. In other words, the amount of energy supplied is reduced, but in view of the charging time an attempt is made to maintain the raised charging current (in the example approx. 28 A) during the charging pulses as long as possible. It is not until a rise in voltage U_{Z} during the charging pulse beyond the end-of-charge voltage U_{Lmax} can no longer be achieved by a reduction of the duration of a charging pulse t_{L}, that a reduction of the charging current can be performed during the charging pulses, if in the load pulses the voltage at the cell U_{Z} is still below the end-of-charge voltage U_{Lmax}. Reducing the duration and/or lowering the charging current continues for so long until either during the load pulses the end-of-charge voltage is reached or the predetermined number m of maximal charging/load pulses is reached. In other words, the charging process is finished when either charging has been completed or when switching forth and back between load and charging pulse has reached a critical number of charging and/or load pulses and the charge state cannot be improved any further.

FIG. 6 shows a complete cycle of a pulse-charging method, wherein the voltage is shown in the upper part and the current is shown in the lower part. It can be clearly recognised that the charging pulses start at 3.5V and rise to 4.3V, wherein when 4.3V are reached during the charging pulses, which corresponds to approx. the end-of-charge voltage U_{Lmax}, a reduction of the charging current during the charging pulses occurs. Up to the point in time, at which the end-of-charge voltage U_{Lmax} is reached, the charging current I_{L} applied compared to the maximum admissible charging current I_{Lmax} is e.g. three times as big in the charging pulses. Once the end-of-charge voltage U_{Lmax} is reached (in the rear quarter of the view) the charging current drops. It can also be recognised that here the duration of the charging pulses is reduced in order to make pulse-charging as efficient as possible.

FIG. 7 shows a flow diagram of the pulse-charging method according to the invention. In step S700 charging of the cell is started. In step S710 the voltage of the cell U_{Z} is measured and it is checked whether the voltage at the cell U_{Z} lies above the end-of-discharge voltage U_{EL}. Preferably this voltage measurement is carried without a load being applied. If it is found that the voltage at the cell U_{Z} is below the end-of-discharge voltage U_{EL} the cell is deeply discharged and a charge-preparing phase must be carried out as indicated in step S711. If the voltage at the cell is above the end-of-discharge voltage U_{EL} it is checked in step S720 whether pulse-charging is desired. If for example there is sufficient time and it is not necessary to perform quick pulse-charging, careful continuous charging of the storage module or cells can be performed (S721). If, however, due to external conditions or demands by the user charging must be effected quickly, pulse-charging according to the invention is started (S730). The height and duration of the charging pulses must be set (S740), wherein in this example the duration of the charging pulses t_{L} is set to 5 s and a current I_{L} of approx. three times the admissible charging current is used. Similarly the height and duration of the load pulse t_{EL} is set, wherein the duration of the load pulse corresponds to approx. one third of the charging pulse (S750). In addition in step S751 the rest periods tp1 and tp2 are set, wherein the times for tp1 and tp2 respectively correspond to a third of the time of the load pulse t_{EL}. The sum of the rest periods and load pulse t_{EL}+tp1+tp2 results in the time tₛₑₙₖₑ outside the charging pulse.

In step S760 the first charging pulse is applied. In step S761 a counter m is incremented for each applied charging pulse, in order to record a maximum number m_{Max} of charging pulses for the later process. In step S762 the charging current I_{L} and the voltage at the cell U_{Z} are measured, wherein in step S763 it is determined whether the voltage at the cell U_{Z} corresponds to the end-of-charge voltage U_{Lmax}. Should the voltage at the cell U_{Z} not correspond to the end-of-charge voltage U_{Lmax}, it is checked, whether the elapsed time t already corresponds to the time of the charging pulse t_{L} (S766). If this is not the case, the process returns to step S762 and continues to check the current/the voltage during the charging pulse. If the voltage of a cell U_{Z} in step S763 however corresponds to the end-of-charge voltage U_{Lmax}, it is checked in step S764 whether the charging current is reduced within the charging pulse. If this is not the case, the process continues with step S766 and the elapsed time t is compared with the time of the charging pulse t_{L}. If however, as clearly shown in FIG. 5, the charging current within the charging pulse is reduced, in order to stop the cell voltage U_{Z} from rising further, the duration of the charging pulses t_{L} is reduced in step S765. The duration of the reduction t_{ΔL} may be set in various ways. For example a fixed value tᵣ, for example 0.2 s, may be used, by which the next charging pulse is reduced by 0.02 s. But it is also possible, to use a variable value which results from the point in time, at which the charging current I_{L} starts to fall during the charging pulse. This time t_{d} of the charging pulse at which the charging current I_{L} sinks and for which this charging pulse is no longer effective for pulse-charging, could therefore be the time by which the next charging pulse is shortened. In other words, the time at which the charging current within the charging pulse no longer has the pre-set triple value of the maximum admissible charging current, is subtracted during the next charging pulse. Preferably, once the charging pulse has been reduced once, it is not extended again for the further pulse-charging process.

Moreover the duration of the charging pulse t_{L} is not reduced any further until another reduction of the charging current is called for during a subsequent charging pulse, which pulse by then has already been reduced in its duration in comparison to the starting value.

Once the charging pulse in step S766 has finished, the charging voltage U_{L} is switched off and the system waits in step S770 for the first rest period tp1 to finish. Then the load pulse is activated in step S780, i.e. the cell or the power pack or the storage module is connected with a sink or load, wherein during this load pulse another voltage measurement is carried out in step S785. If during the load pulse the cell reaches the end-of-charge voltage U_{Lmax} the charging process is finished. In order to prevent measuring errors the system may wait for a further load pulse to take place during which the cell should again have the end-of-charge voltage U_{Lmax}.

If the end-of-charge voltage U_{Lmax} is not reached during the load pulse, a further rest period occurs between the load pulse and the next charging pulse. Then a check is carried out, whether the maximum number of charging and/or load pulses has been reached (S795). This check may also be carried out prior to applying the first charging pulse, or at another suitable point in time.

Once the maximum number m_{Max} of charging pulses has been reached, the charging process has finished. This is intended to prevent an inefficient switching back and forth between charging pulse and load pulse in the lower area, i.e. for an achieved end-of-charge voltage U_{Lmax} during the charging pulses and reduced currents during the charging pulses, because this counteracts quick charging of the cell and further degeneration of the cell. If the pre-set maximum value m_{Max} of charging and load pulses has not yet been reached, the system returns to S760 in order to apply the next charging pulse. The maximum number m_{Max} may define the number of charging pulses or the number of load pulses. Or both pulse types may be counted. The maximum number m_{Max} is based on empirical values and in the following example is limited to 1010 pulses.

FIG. 8 shows a flow diagram for a pulse-charging method according to the invention, in which both a charge-preparing phase and a pulse-charging phase are carried out. After starting the charging process in step S301, the cell voltage U_{Z} is initially measured (S302). If the voltage U_{Z} is greater than the end-of-charge voltage U_{Lmax}, i.e. if in case of a high-energy cell more than 4.2V are present at the cell, the cell is completely charged, and the charging process is finished. If the cell voltage U_{Z} is smaller than the end-of-charge voltage U_{Lmax} it is checked in step S303 whether the cell voltage is greater than an end-of-discharge voltage U_{EL}. The end-of-discharge voltage U_{EL} of a high-energy cell is about 2.5V and 2V for high current cell. If the cell voltage U_{Z} is higher than the end-of-discharge voltage U_{EL}, the pulse-charging process as per FIG. 7 can immediately continue. But if the cell voltage U_{Z} is less than the end-of-discharge voltage U_{EL}, a charge-preparing phase for activating the cell must be carried out.

Thus in step S304 a first rising phase (33 in FIG. 3) takes place. For example the cell here is charged for a minute with a linearly rising charging current up to maximally its admissible charging current I_{L}, or a predefined value. After charging the cell during the first rising phase 33, the cell voltage U_{Z} is measured under load. This means it is checked what the strength of the voltage U_{Z} at the cell is when under load. If the voltage U_{Z} is greater than the end-of-discharge voltage U_{EL} of 2.5V or 2V, depending on the cell in use, the pulse-charging phase can begin. Otherwise, a first rising phase is repeated in steps S306. Should the cell voltage, after repeating the first rising phase, still lie below the end-of-discharge voltage U_{EL}, a second rising phase is applied, using a charging current I_{L} of more than the admissible charging current I_{Lmax} (S308). Although not shown in FIG. 8 a check is carried out after completing the second rising phase, whether the cell voltage U_{Z} has reached the end-of-discharge voltage U_{EL}. If the cell voltage U_{Z} after the second rising phase has still not reached the end-of-discharge voltage U_{EL}, the cell is defective and cannot be charged any further. The pulse-charging phase shown in FIG. 7 can only be performed on condition that the end-of-discharge voltage U_{EL} has been reached. After the pulse-charge phase has started, a charging pulse is initially applied for a time duration t_{L} with a charging current I_{L}, which is greater than the admissible charging current I_{Lmax}. Following the charging pulse a load pulse is applied which preferably is only half as long or 30% as long as the charging pulse, and where the cell is loaded with a discharging current I_{Last} of about 25% of the admissible charging current I_{Lmax}. During the charging pulse the cell voltage U_{Z} is measured, and it is checked whether the cell voltage U_{Z} is greater than the end-of-charge voltage U_{Lmax}. Should the voltage U_{Z} should already lie above the end-of-charge voltage U_{Lmax}, it is checked whether the end-of-charge voltage has already been reached. If this is the case, the cell is completely charged.

FIG. 9 shows a detailed charge-preparing phase. In the upper signal characteristic of FIG. 9 it can be recognised that the cell is initially charged with a linearly rising current up to an amperage of 1 A, wherein during this time the voltage at the cell rises from about 3.5V to 3.7V. During the following load phase a voltage measurement is again carried out. After the first rising phase it can be recognised that the voltage U_{Z} at the cell lies below 2.0V, which is less than the end-of-discharge voltage U_{EL}, so that a further first rising phase must be carried out, since the presence of the end-of-discharge voltage U_{EL} is the prerequisite for starting the pulse-charging phase. After the first rising phase has been repeated, a voltage measurement is again carried out, which indicates that the cell after repeating the first rising phase comprises a voltage of 2.1V (2.5V not shown), which is higher than the end-of-discharge voltage U_{EL} of e.g. a high-current cell (high-energy cell). Depending on the embodiment a second rising phase can now be performed, during which the cell is charged to an amperage above the admissible charging current I_{Lmax}. Alternatively it is possible to immediately continue with the pulse-charging process.

In FIG. 10 a device for performing a charging method is described. The device for performing the charging method is normally called a charging device. In contrast to conventional charging devices a charging device for performing the charging method is capable of applying a defined sink or a defined load pulse to the cell. The charging device 100 is connected with the storage module or power pack 140. The storage module comprises several cells 140 connected in series which are connected with a temperature sensor 160, which is coupled with the charging device 100 for continuous or periodical temperature monitoring. The charging device 100 comprises a CPU 110 for performing the charging method according to the invention. The CPU is connected with a memory 120 and with a display 130 for outputting measured values. Further the charging device comprises an input unit 150, via which the charging process can be influenced, for example the type of the cell to be charged can be input. The memory has various parameters for different cell types for the charging process stored in it. For example the characteristics for a certain cell can be stored such as capacity, end-of-charge voltage, nominal voltage, end-of-discharge voltage, maximum charging current, maximum discharging current and continuous discharging current. On the basis of these values the height of the charging pulses/the load pulses is calculated and also the times such as TL, t_{EL}, tp1, tp2. Further, critical temperature values can be stored in the memory 120, which are related to the respective cell type. Preferably the charging device comprises a detection device in order to be able to identify the cell to be charged. It is also possible for the type of cell to be input via the input means. The CPU 110 of the charging device measures, depending upon the charging method, the voltage U_{Z} and/or the current in the load/charging pulses. Preferably the charging device 100 comprises at least one capacitor which is used for providing the charge for the charging pulse. It is also possible to use the at least one capacitor for discharging during the load pulse, wherein the stored charge is then discharged via a resistance. Further a counter 121 is present which counts the number of charging/load pulses in order to prevent the storage module 140 from switching back and forth between reduced charging pulses/load pulses, where no efficient utilisation of the pulse-charging method is given.

FIG. 11 shows a storage module such as used for the pulse-charging method according to FIGS. 4-6. The storage module contains 2×5 cells, wherein five are respectively connected in parallel and the two packs of five are again connected in parallel. In other words, the 10 cells are electrically connected in parallel, wherein respectively five cells are present at a terminal lug or busbar.

1-15. (canceled)

16. A method for charging at least one lithium-ion-based rechargeable cell, the method comprising the steps of:
pulsed charging of the cell wherein the charging current I_{L}, during the charging pulses, exceeds the admissible maximum charging current I_{Lmax} of the cell, by up to five time the value; and
the cell is discharged between the charging pulses by means of load pulses, wherein the load pulses are shorter than the charging pulses,
wherein after reaching the end-of-charge voltage U_{Lmax} during a charging pulse the duration of the charging pulses is reduced, wherein charging of the cell is finished,
when a predefined number (n) of load pulses is reached, where the measured voltage U_{Z} corresponds to the end-of-charge voltage U_{Lmax} of the cell, or
when a predetermined maximum number mMax of applicable charging and load pulses is reached.

17. The method according to claim 16, comprising the steps of:
checking whether a voltage U_{Z} being present at the cell during a load pulse, which voltage at least corresponds to an end-of-discharge voltage U_{EL} of the cell or whether an external signal is applied which is an indication for performing the pulse-charging method,
wherein the pulse-charging method starts, if at least one of the predefined conditions for the pulsed charging of the cell has been met.

18. The method according to claim 16, wherein before and/or after a load pulse a predetermined rest period tp1, tp2 is provided, in which the voltage supply to the cell is switched off, wherein the rest period tp1, tp2 is dependent on the number and the capacity of the cells to be charged.

19. The method according to claim 18, wherein for a rising number of cells to be charged and coupled to a terminal element, the predetermined rest period tₚ₁, tₚ₂ increases.

20. The method according to claim 16, wherein depending on the voltage measurement during the charging pulses the level of the charging current I_{L} is set for the current charging pulse, wherein, when the voltage U_{Z} of the cell reaches the end-of-charge voltage U_{Lmax} during the charging pulse, the duration of the charging pulse t_{L} for the next charging pulse is reduced.

21. The method according to claim 20, wherein after reaching the end-of-charge voltage U_{Lmax} during the charging pulse, the charging current I_{L} is reduced during the current charging pulse.

22. The method according to claim 16, wherein the voltage U_{Z} of the cell is measured at least outside the charging pulses in order to determine whether the cell reaches the end-of-charge voltage U_{Lmax} of the cell outside the charging pulse, preferably during the load pulse.

23. The method according to claim 16, wherein the level of the charging current I_{L}, during the charging pulses and/or the level of the discharging current I_{Last} during the load pulses is set depending on the cell and depending on the internal resistance of the cell and the temperature of the cell.

24. The method according to claim 16, wherein during a load pulse a discharging current I_{Last} of 50% to 100% of the charging current I_{L} of the charging pulse flows.

25. The method according to claim 16, wherein the level of the charging current I_{L} is different in consecutive charging pulses and the level of the discharging current I_{Last} is different in consecutive load pulses.

26. The method according to claim 16, wherein the charging operation is terminated or interrupted, if a predefined temperature (Tₘₐₓ) of the cell is exceeded.

27. The method according to claim 16, where the length t_{EL} of a load pulse corresponds to approx. ⅓ of the length t_{L} of a charging pulse.

28. A device comprising:
a sink and load in order to discharge the cell during the load pulses, wherein the duration and height of the load pulse are adjustable; and
at least one capacitor which is charged during the load pulse and discharged during the charging pulse.

29. The device according to claim 28, further comprising:
a memory for storing various parameters for the charging method;
a display for outputting measured values;
an input unit for manually influencing the charging method and for inputting predetermined values, for example at least one of the following values: end-of-charge voltage U_{Lmax}, duration of charging pulse t_{L}, duration of load pulse t_{EL}, duration of rest period prior to a load pulse tₚ₁, duration of rest period after a load pulse tₚ₂, value for reducing the load pulse t_{d},
a temperature sensor for continuous or periodical temperature monitoring of the cell,
a storage module which contains at least one lithium-ion based rechargeable cell, and
a counter for recording the number of charging pulses and load pulses during the pulse-charging process.
